(19) United States
(12) Patent Application Publication
(10) Pub. No.: US 2019/0261075 A1
(43) Pub. Date: Aug. 22, 2019

(54) SPEAKER DEVICE

(71) Applicant: Panasonic Intellectual Property Management Co., Lt, Osaka (JP)

(72) Inventors: MINORU UMESAKO, Hyogo (JP); TAKUTO TAKIZAWA, Osaka (JP); YUKIHARU WAKIGUCHI, Osaka (JP); HIROYA MORIKAWA, Osaka (JP)

(21) Appl. No.: 16/312,543

(22) PCT Filed: Jul. 4, 2017
(86) PCT No.: PCT/JP2017/024475

§ 371 Date: Dec. 21, 2018

(30) Foreign Application Priority Data
Jul. 11, 2016 (JP) 2016-137182

(51) Int. Cl. H04R 1/02; H04R 1/26; H04R 1/34

(52) U.S. Cl. CPC H04R 1/028; H04R 1/345; H04R 1/26; H04R 1/025

(57) ABSTRACT

A speaker device includes a housing that has a sound guide space having a vertically flattened shape, a first speaker disposed in the housing to be oriented toward a front of the housing, and a second speaker that is disposed in the housing and is oriented upward or downward to output sound into the sound guide space positioned at an internal upper part or an internal lower part of the housing. The sound guide space opens at an opening that is formed in vertically flattened form in the housing, and the opening has a vertical height that is smaller than an aperture of the first speaker.

### TECHNICAL FIELD

The present disclosure relates to a speaker device.

### BACKGROUND ART

A speaker device disclosed by PTL 1 is installed, as a member separate from a television set (hereinafter also referred to as “TV”), in a lower front position of the television set and is used as an audio output device of the television set. This speaker device includes a housing that is rectangular when its front is viewed from in front, and a plurality of speakers disposed at the front of the housing.

### CITATION LIST

### Patent Literature

PTL 1: Unexamined Japanese Patent Publication No. 2012-244442

### SUMMARY

The present disclosure provides a speaker device that emits sounds forward and can achieve both size increase of an aperture of a speaker and suppressed height increase of a housing.

A speaker device according to one aspect of the present disclosure includes a housing that has a sound guide space having a vertically flattened shape, a first speaker disposed in the housing to be oriented toward a front of the housing, and a second speaker disposed in the housing, the second speaker being oriented upward or downward to output sound into the sound guide space that is positioned at an internal upper part or an internal lower part of the housing. The sound guide space opens at an opening that is formed in vertically flattened form in the housing, and the opening has a vertical height that is smaller than an aperture of the first speaker.

The speaker device of the present disclosure is a speaker device that emits sounds forward and can achieve both size increase of an aperture of the speaker and suppressed height increase of the housing.

### BRIEF DESCRIPTION OF DRAWINGS

FIG. 1 is a front elevation schematically illustrating an example of installation of a speaker device according to a first exemplary embodiment.

FIG. 2 is a perspective view schematically illustrating an example of external appearance of the speaker device according to the first exemplary embodiment.

FIG. 3 is a perspective view schematically illustrating an example of a state in which a front panel is removed from the speaker device according to the first exemplary embodiment.

FIG. 4 is a front elevation schematically illustrating the example of the state in which the front panel is removed from the speaker device according to the first exemplary embodiment.

FIG. 5 is a sectional view schematically illustrating a structural example of the speaker device according to the first exemplary embodiment.

FIG. 6 is a sectional view schematically illustrating the structural example of the speaker device according to the first exemplary embodiment.

### DESCRIPTION OF EMBODIMENTS

Exemplary embodiments are hereinafter described in detail with reference to the drawings where appropriate. It is to be noted, however, that detailed descriptions that are more than necessary may be omitted. For example, detailed descriptions of already well-known matters and repeated descriptions of substantially the same structures may be omitted. This is for the purpose of preventing the following description from needlessly having redundancy, thereby facilitating understanding by those skilled in the art.

In the following description of the exemplary embodiments, an expression including “substantially”, such as “substantially parallel” or “substantially orthogonal”, may be used. For example, “substantially parallel” implies not only “completely parallel”, but also “approximately (or virtually) parallel”. “Substantially” here implies inclusion of a range that is not problematic in practical use. In other words, the expression including “substantially” implies allowance of a difference falling within the range that is not problematic in practical use.

It is to be noted that the accompanying drawings and the following description are provided for those skilled in the art to fully understand the present disclosure and are not intended to limit the subject matter as described in the claims.

The drawings are not necessarily exact illustrations, but schematic views in which emphasis, omission, and proportion adjustment are made as required for illustration of the present disclosure, and these drawings may have shapes, positional relationships, and proportions that differ from actual shapes, actual positional relationships, and actual proportions. In the drawings, substantially identical constituent elements have the same reference marks, and descriptions of those constituent elements may be omitted or simplified.

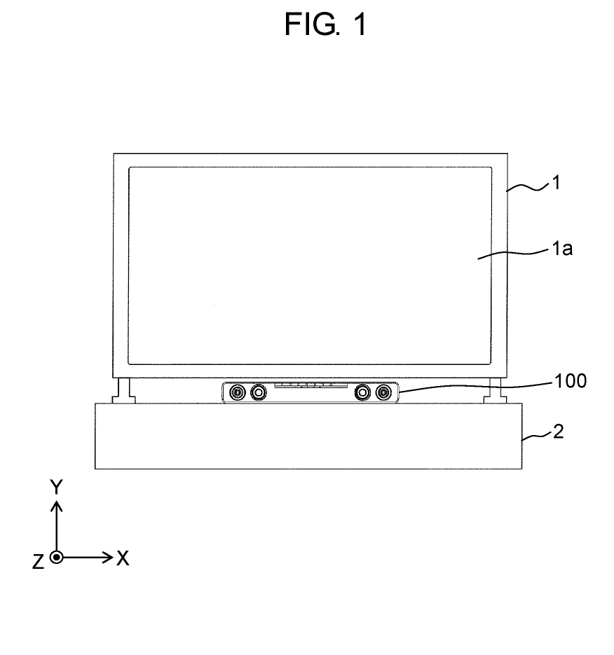

The exemplary embodiments of the present disclosure are described below with reference to FIGS. 1 to 6. Three axes, i.e., an X-axis, a Y-axis, and a Z-axis are shown in the drawings for use on an as needed basis in the following description of the exemplary embodiments. In these exemplary embodiments, for convenience' sake, a line parallel (substantially parallel) to a long side of television set 1 is taken as the X-axis, a line parallel (substantially parallel) to a short side of television set 1 is taken as the Y-axis, and a line orthogonal to both the X-axis and the Y-axis is taken as the Z-axis. As such, image display surface 1a of television set 1 is parallel (substantially parallel) to an X-Y plane in the following description. A line vertical to the X-Y plane, namely, the Y-axis is a line of gravity, and a direction in which gravity acts is taken as a negative direction of the Y-axis. Under normal conditions of use, television set 1 is mounted on television stand 2 that is installed on an installation surface (horizontal plane) parallel (substantially parallel) to an X-Z plane with image display surface 1a facing forward (in a positive direction of the Z-axis). It is to be noted that the installation surface on which television stand 2 is installed is not shown in the drawings. A television set side that faces a user (not illustrated) viewing television set 1 is taken as a “front” or “forward side”, while a television set side opposite from the front is taken as a “rear”. A direction from the rear to the front of television set 1 is taken as “forward” or the positive direction of the Z-axis. Relative remoteness from the installation surface in a positive direction of the Y-axis is taken as “upward”, while relative proximity to the installation surface is taken as “downward”. In the following description, there are also cases where the Y-axis is described as “heightwise” or “vertically”, the X-axis is described as “horizontally” or a “left-right line”, the Z-axis is described as “depthwise” or a “front-back line”, and a plane parallel to the X-Z plane is described as “horizontal”. It is to be noted that these lines are not absolute lines, but relative lines that are shown for convenience.

### First Exemplary Embodiment

### 1-1. Structure of Speaker Device

With reference to the drawings, a description is hereinafter provided of structure of speaker device 100 according to the first exemplary embodiment.

FIG. 1 is a front elevation schematically illustrating an example of installation of speaker device 100 according to the first exemplary embodiment. FIG. 1 schematically illustrates how speaker device 100 is being installed on television stand 2 together with television set 1.

As illustrated in FIG. 1, speaker device 100 is formed as a member separate from television set 1 and is installed, together with television set 1, on television stand 2 that is used for mounting of television set 1. Specifically, speaker device 100 is installed on television stand 2 so that, for example, a front of speaker device 100 is positioned forwardly of image display surface 1a of television set 1 (in the positive direction of the Z-axis) below image display surface 1a (in the negative direction of the Y-axis) while having its orientation adjusted to be substantially parallel to image display surface 1a. In the following description, speaker device 100 is set in such a state and is installed on television stand 2 together with television set 1. Speaker device 100 is electrically connected to television set 1 and outputs sound of television set 1 upon receiving an audio signal output from television set 1.

Speaker device 100 has the outside shape of a substantially rectangular parallelepiped that is long along the left-right line (along the X-axis) and is vertically thin (along the Y-axis). Speaker device 100 may have such a vertical height (Y-axis dimension) as to fit in, for example, a space between image display surface 1a and television stand 2. However, the present disclosure is not limited to this structure at all. It is to be noted that speaker device 100 is formed to output sound in a forward direction (in the positive direction of the Z-axis) from image display surface 1a.

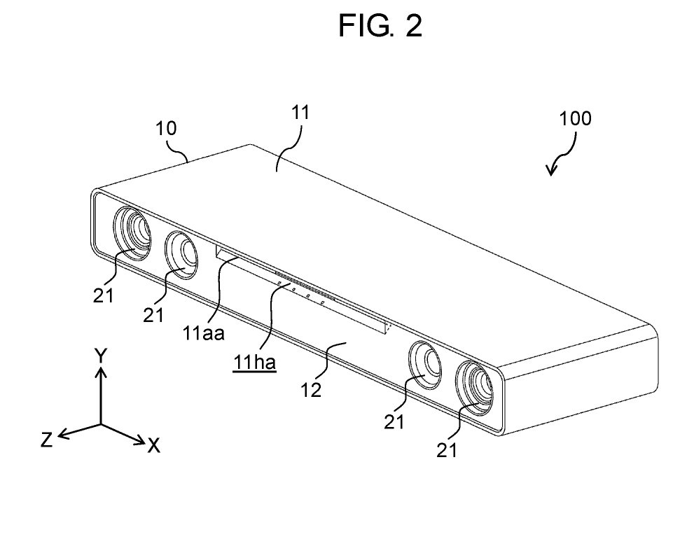

With reference to FIGS. 2 to 4, the structure of speaker device 100 is described next.

FIG. 2 is a perspective view schematically illustrating an example of external appearance of speaker device 100 according to the first exemplary embodiment.

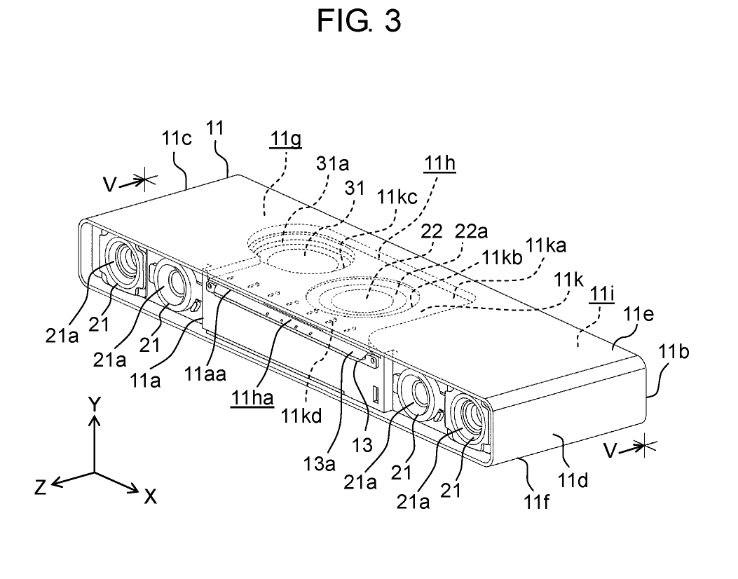

FIG. 3 is a perspective view schematically illustrating an example of a state in which front panel 12 is removed from speaker device 100 according to the first exemplary embodiment.

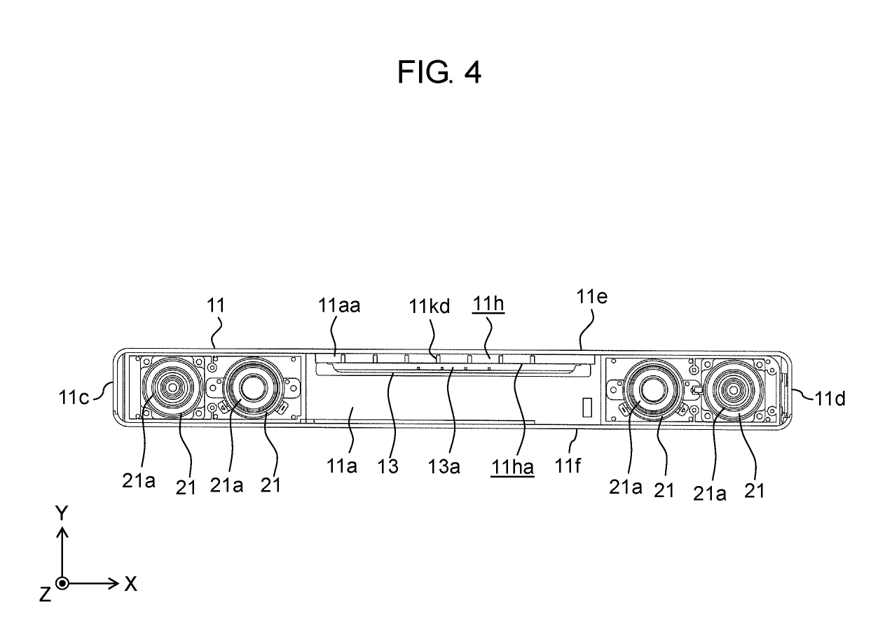

FIG. 4 is a front elevation schematically illustrating the example of the state in which front panel 12 is removed from speaker device 100 according to the first exemplary embodiment.

As illustrated in FIG. 2, speaker device 100 includes housing 10 that has a vertical (Y-axis) side shorter than its other two sides. Housing 10 thus has the outside shape of a rectangular parallelepiped that is vertically flattened (along the Y-axis) in form. Housing 10 includes hollow main body 11 having the shape of a rectangular parallelepiped that is vertically flattened (along the Y-axis), and front panel 12 that has the shape of a flat plate to be mounted to a front of main body 11.

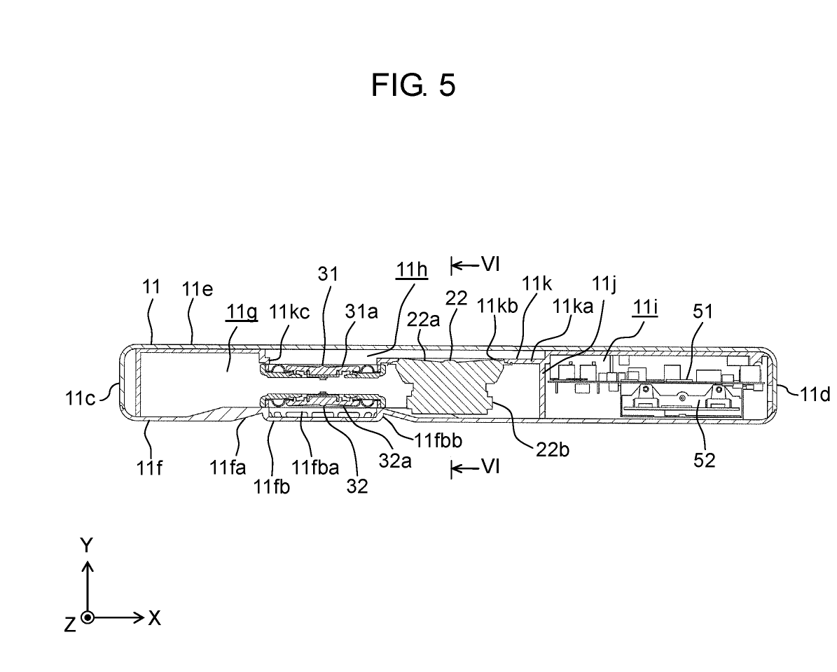

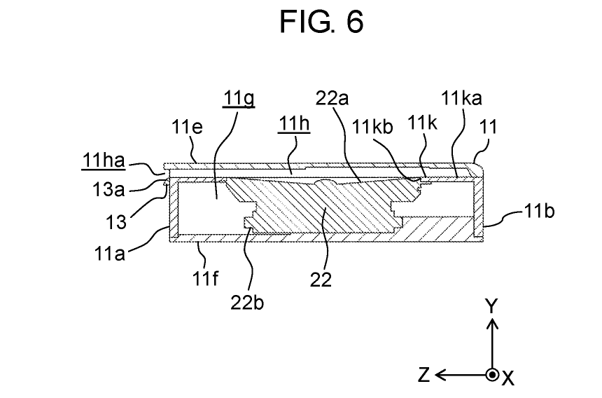

As illustrated in FIG. 3, main body 11 has front wall 11a, rear wall 11b (refer to FIG. 6), side wall 11c (refer to FIG. 5), side wall 11d, top wall 11e, and bottom wall 11f (refer to FIGS. 5 and 6). Housing 10 is made of a rigid material that can stably maintain the shape of housing 10. Given examples of the material used for making housing 10 include metal, resin, wood, glass, and fiber. It is to be noted that housing 10 is not limited to the above-described shape.

Front wall 11a and rear wall 11b each have the shape of a rectangular plate that has a horizontal (X-axis) length greater than its vertical (Y-axis) length. Front wall 11a and rear wall 11b are substantially identical in shape and have substantially the same dimensions. The respective horizontal (X-axis) lengths of front and rear walls 11a and 11b are each set substantially equal to a horizontal (X-axis) length of top wall 11e. Front wall 11a and rear wall 11b are disposed to face each other; front wall 11a is disposed at the front of main body 11 and rear wall 11b is disposed at a rear of main body 11. As such, when speaker device 100 is installed on television stand 2 together with television set 1, front wall 11a is disposed closer to image display surface 1a of television set 1, while rear wall 11b is disposed closer to the rear of television set 1. As illustrated in FIG. 3, front wall 11a is positioned closer to the rear of main body 11 (in a negative direction of the Z-axis) than respective front edges of side wall 11c, side wall 11d, top wall 11e, and bottom wall 11f are. This is for the purpose of enabling front panel 12 to be disposed in front of front wall 11a (in the positive direction of the Z-axis) as shown in FIG. 2.

Side walls 11c and 11d each have the shape of a rectangular plate that has a depthwise (Z-axis) length greater than its vertical (Y-axis) length. Side walls 11c and 11d are substantially identical in shape and have substantially the same dimensions. The respective vertical (Y-axis) lengths of side walls 11c and 11d are each set substantially equal to the vertical (Y-axis) length of each of front and rear walls 11a and 11b. Side walls 11c and 11d are disposed to face each other. When speaker device 100 is viewed from in front in the negative direction of the Z-axis, side wall 11c is disposed at a left side of main body 11, while side wall 11d is disposed at a right side of main body 11. As such, when speaker device 100 is installed on television stand 2 together with television set 1, side wall 11c is disposed leftwardly of a middle of television set 1, while side wall 11d is disposed rightwardly of the middle of television set 1. The respective depthwise (Z-axis) lengths of side walls 11c and 11d are each shorter than the horizontal (X-axis) length of top wall 11e. As such, when speaker device 100 is viewed from above in the negative direction of the Y-axis, main body 11 is rectangular, being long along the X-axis.

Top wall 11e and bottom wall 11f each have the shape of a rectangular plate that has a horizontal (X-axis) length greater than its depthwise (Z-axis) length. As described later, bottom wall 11f is formed with depression 11fa (refer to FIG. 5). Except for this point, top wall 11e and bottom wall 11f are substantially identical in shape and have substantially the same dimensions. The respective depthwise (Z-axis) lengths of top and bottom walls 11e and 11f are each set substantially equal to the depthwise (Z-axis) length of each of side walls 11c and 11d. The respective horizontal (X-axis) lengths of top and bottom walls 11e and 11f are each set substantially equal to the horizontal (X-axis) length of each of front and rear walls 11a and 11b. Top wall 11e and bottom wall 11f are disposed to face each other; top wall 11e is disposed at a top of main body 11 and bottom wall 11f is disposed at a bottom of main body 11. As such, when speaker device 100 is installed on television stand 2 together with television set 1, top wall 11e is disposed closer to television set 1, while bottom wall 11f is disposed closer to television stand 2.

By having such above structure, main body 11 is vertically flattened (along the Y-axis) in form. Rear wall 11b, side wall 11c, side wall 11d, top wall 11e, and bottom wall 11f form an exterior of housing 10, thus forming a design for speaker device 100.

Front wall 11a of main body 11 is formed with, at its upper central part, slit 11aa passing through front wall 11a. In the present exemplary embodiment, internal space 11h of main body 11 communicates with an exterior of main body 11 by way of slit 11aa. Slit 11aa has the shape of a slender rectangle that runs horizontally (along the X-axis) and has a horizontal (X-axis) length greater than its vertical height (Y-axis length). In other words, slit 11aa has a vertically flattened shape. Slit 11aa is an example of an opening that is formed in vertically flattened form in housing 10. In the present exemplary embodiment, the vertical height (Y-axis length) of slit 11aa is set smaller than an aperture (e.g. 4 cm) of first speaker 21. The vertical height of slit 11aa is, for example, about 1 cm. However, slit 11aa is not limited to this size at all.

A plurality of first speakers 21 are embedded in front wall 11a. The plurality of first speakers 21 are arranged in a horizontal line (along the X-axis) with their sound output directions being forward so as to output sounds forward. In other words, housing 10 has the plurality of speakers 21 that are arranged to be oriented forward (in the positive direction of the Z-axis) in the present exemplary embodiment. In the present exemplary embodiment, speaker device 100 includes four first speakers 21, two of which line up horizontally (along the X-axis) on a left side of slit 11aa while the other two line up horizontally (along the X-axis) on a right side of slit 11aa. It is to be noted that instead of having first speakers 21 embedded in front wall 11a, speaker device 100 may be formed so that the horizontal (X-axis) length of front wall 11a is shorter than the horizontal (X-axis) length of top wall 11e to allow first speakers 21 to be arranged between front wall 11a and side wall 11c as well as between front wall 11a and side wall 11d.

First speaker 21 is, for example, a small-size full-range speaker with an aperture that is about 4 cm in diameter. First speaker 21 has such a frequency characteristic as to suitably enable reproduction of sound in a specified frequency band. The specified frequency band ranges, for example, from 100 Hz to nearly 50 kHz or from 100 Hz to over 50 kHz. First speaker 21, however, is not limited to this frequency characteristic at all. First speaker 21 may be, for example, a tweeter that can suitably reproduce sound in a specified high-range frequency band that ranges, for example, from 1 kHz to nearly 100 kHz or from 2 kHz to over 100 kHz.

The frequency characteristic of each of two first speakers 21 that are disposed relatively closer to slit 11aa may be different from the frequency characteristic of each of two first speakers 21 that are disposed relatively farther from slit 11aa. In this case, it is not two first speakers 21 disposed relatively closer to slit 11aa, but those two first speakers 21 disposed relatively farther from slit 11aa that may be suitable to output high-range sounds.

FIG. 5 is a sectional view schematically illustrating a structural example of speaker device 100 according to the first exemplary embodiment. The FIG. 5 sectional view of speaker device 100 is taken along line V-V of FIG. 3.

FIG. 6 is a sectional view schematically illustrating the structural example of speaker device 100 according to the first exemplary embodiment. The FIG. 6 sectional view of speaker device 100 is taken along line VI-VI of FIG. 5.

As shown in FIGS. 3 to 6, three internal spaces 11g, 11h, and 11i are formed in mutually divided relationship inside main body 11 of housing 10.

As illustrated in FIG. 5, internal space 11g and internal space 11i are separated from each other by partition 11j that is provided vertically (along the Y-axis) to be upright in main body 11, and internal spaces 11g and 11i adjoin horizontally (along the X-axis) via partition 11j. In other words, internal spaces 11g and 11i are divided from each other by partition 11j without communicating with each other. Similarly, internal space 11h and internal space 11i are divided from each other without communicating with each other.

Internal space 11h and internal space 11g are separated from each other by partition 11k that is shaped into a bottomed tube in vertically flattened form (along the Y-axis) as illustrated in FIG. 3 (see a part indicated by broken lines) and FIG. 5. Partition 11k has planarly extending floor partition 11ka that is provided directly under top wall 11e (in the negative direction of the Y-axis) inside main body 11 to be substantially parallel to top wall 11e in spaced relation to top wall 11e. As such, internal spaces 11h and 11g adjoin vertically (along the Y-axis) via floor partition 11ka with internal space 11h being disposed above internal space 11g (in the positive direction of the Y-axis).

Together with top wall 11e, floor partition 11ka surrounds an internal part of main body 11, so that internal space 11h is formed. Floor partition 11ka is formed with two circular openings 11kb and 11kc, and internal space 11h communicates with internal space 11g via openings 11kb and 11kc. It is to be noted that the openings formed in floor partition 11ka are not limited to two in number. There may be one opening or not less than three openings to be formed in floor partition 11ka.

A vertical space (Y-axis clearance) between floor partition 11ka and top wall 11e is set substantially equal to the vertical height (Y-axis length) of slit 11aa. As such, a vertical height (Y-axis dimension) of internal space 11h is substantially equal to the vertical height (Y-axis length) of slit 11aa, and internal space 11h stretches (depthwise or along the Z-axis) along top wall 11e from front wall 11a to rear wall 11b while maintaining its height. A width (X-axis dimension) of internal space 11h may be substantially equal to the width (X-axis dimension) of slit 11aa. Moreover, internal space 11h may partly have a width that is greater than the width of slit 11aa. Internal space 11h communicates with the exterior of main body 11 via slit 11aa. Internal space 11h thus forms a sound guide space that as a passage, guides sound in a direction from rear wall 11b to front wall 11a.

As described above, internal space 11h, which is the sound guide space, is formed to include top wall 11e and floor partition 11ka of housing 10 and extends (depthwise or along the Z-axis) from front wall 11a to rear wall 11b of housing 10 while having the vertical height substantially equal to the vertical height (e.g. 1 cm) of slit 11aa, which is the opening. In other words, housing 10 of speaker device 100 has the sound guide space (internal space 11h) having a vertically flattened shape, and this sound guide space opens onto the exterior of main body 11 at the opening (slit 11aa) that is formed in vertically flattened form in housing 10. Internal space 11h, which is the sound guide space, has, at least near slit 11aa, a passage section of the same shape as slit 11aa. It is to be noted that in the present disclosure, the shape of internal space 11h, which is the sound guide space, is not limited to the above-described shape at all.

In the present exemplary embodiment, slit 11aa is formed to have the width (X-axis length) that is greater a diameter of opening 11kb. Opening 11kb is disposed midway between side walls 11c and 11d to be aligned with slit 11aa behind slit 11aa when speaker device 100 is viewed from in front in a depthwise direction (negative direction of the Z-axis) that is substantially parallel to the horizontal plane (X-Z plane). Opening 11kb is thus included in an area (extending from slit 11aa in the negative direction of the Z-axis) behind slit 11aa when speaker device 100 is viewed from in front in the Z-axis negative direction that is substantially parallel to the horizontal plane (X-Z plane). In other words, opening 11kb is disposed at a position to overlap slit 11aa (in the rear of slit 11aa) when the front of speaker device 100 is viewed from in front in the direction substantially parallel to the horizontal plane (X-Z plane). It is to be noted that “midway” mentioned above is a position of opening 11kb in the rear of slit 11aa.

Opening 11kc is disposed next to opening 11kb (e.g. on an X-axis negative side of opening 11kb, namely, between opening 11kb and side wall 11c).

As illustrated in FIGS. 3 and 4, a plurality of guides 11kd are formed on floor partition 11ka near slit 11aa in internal space 11h, which is the sound guide space. Guides 11kd are belt-shaped projections that are long depthwise (along the Z-axis). The plurality of guides 11kd are arranged in a horizontal line (along the X-axis) in mutually spaced relationship (substantially at equal intervals) to be substantially parallel to one another. Guides 11kd are members that give directivity to sound that is emitted toward the exterior of main body 11 through the sound guide space (internal space 11h) and slit 11aa.

As illustrated in FIG. 4, front wall 11a of main body 11 is mounted with elongated directional member 13 having a length substantially equal to the (X-axis) width of slit 11aa. Directional member 13 is disposed to directly underlie slit 11aa while being long horizontally (along the X-axis). As such, directional member 13 directly underlying slit 11aa extends substantially throughout the whole (X-axis) width of slit 11aa.

As illustrated in FIGS. 4 and 6, directional member 13 has, as an upper side of directional member 13 (in the positive direction of the Y-axis), directional surface 13a that slopes diagonally to the lower front (in the positive direction of the Z-axis as well as in the negative direction of the Y-axis) from a bottom (lower side) of slit 11aa. Directional surface 13a forms diffusive lead-through part 11ha with top wall 11e. Diffusive lead-through part 11ha is a sound passage that diffuses forward (in the positive direction of the Z-axis) and downward (in the negative direction of the Y-axis) air released from the sound guide space (internal space 11h) through slit 11aa. Diffusive lead-through part 11ha is an example of a divergent opening.

Diffusive lead-through part 11ha is shaped by top wall 11e and directional surface 13a to spread vertically (along the Y-axis) while heading forward (in the positive direction of the Z-axis) (or to broaden toward its end). Accordingly, when sound is emitted from the sound guide space (internal space 11h) that has, for example, such an exit, the emitted sound is diffused forwardly of slit 11aa (in the positive direction of the Z-axis) between a substantially horizontal line and a downward line (negative direction of the Y-axis).

It is to be noted that directional surface 13a of the present exemplary embodiment has, as illustrated in FIG. 6, the form of a convex surface that gently curves in the sloping direction. Thus, a relatively increased range of diffusion can be achieved for air that is released from the sound guide space (internal space 11h). However, the present disclosure is not limited to this structural example. Directional surface 13a may be flat. While directional member 13 shown in the structural example of the present exemplary embodiment is formed separately from main body 11, directional member 13 may be formed integrally with main body 11.

Front panel 12 mounted to the front (positioned in the positive direction of the Z-axis) of main body 11 is a member covering a front surface (positioned in the positive direction of the Z-axis) of front wall 11a. However, front panel 12 exteriorly exposes, as illustrated in FIG. 2, the open end of diffusive lead-through part 11ha, which is formed by directional surface 13a and top wall 11e, and respective front surfaces (from which sounds are emitted) of four first speakers 21. Front panel 12 forms the exterior of housing 10 to form the design for speaker device 100.

As illustrated in FIGS. 3, 5, and 6, one second speaker 22 is fit into opening 11kb provided in floor partition 11ka, while one first passive radiator 31 is fit into opening 11kc provided in floor partition 11ka. In this way, openings 11kb and 11kc are closed, so that the mutual communication between the sound guide space (internal space 11h) and internal space 11g is cut off. Thus, internal space 11g becomes a closed space, and the sound guide space (internal space 11h) becomes a closed space if slit 11aa is excluded.

As illustrated in FIGS. 5 and 6, second speaker 22 disposed in opening 11kb has its diaphragm 22a exposed to the sound guide space (internal space 11h). Second speaker 22 is installed in a preset direction to output sound toward top wall 11e of housing 10. In other words, second speaker 22 is disposed in housing 10 with its sound output direction being upward (the positive direction of the Y-axis) so as to output sound into the sound guide space (internal space 11h) that is positioned above second speaker 22 (in the positive direction of the Y-axis).

Compared with first speaker 21, second speaker 22 is a speaker that can suitably reproduce low-range sound. Second speaker 22 is, for example, a subwoofer having a larger aperture (e.g. about 8 cm in diameter) than that of first speaker 21. Second speaker 22 has such a frequency characteristic as to suitably enable reproduction of sound in a specified low-range frequency band. The specified low-range frequency band ranges, for example, from 20 Hz to 100 Hz or from 20 Hz to 200 Hz. However, second speaker 22 is not limited to this frequency characteristic at all. Second speaker 22 may be, for example, a woofer that can suitably reproduce sound in a specified low- to mid-range frequency band that ranges, for example, from 20 Hz to 2000 Hz.

First speakers 21 each include cone-shaped diaphragm 21a that produces sound, and a drive unit (not shown) that drives diaphragm 21a. Second speaker 22 includes cone-shaped diaphragm 22a that produces sound, and drive unit 22b that drives diaphragm 22a.

On the other hand, first passive radiator 31 includes diaphragm 31a that is, for example, cone-shaped but does not include a drive unit that drives diaphragm 31a.

As illustrated in FIG. 5, first passive radiator 31 disposed in opening 11kc has its diaphragm 31a exposed to the sound guide space (internal space 11h). First passive radiator 31 is installed in a preset direction so that diaphragm 31a faces top wall 11e of housing 10. In other words, first passive radiator 31 is disposed in housing 10 with an axis of cone-shaped diaphragm 31a in substantially parallel relation to an axis of cone-shaped diaphragm 22a of second speaker 22.

First passive radiator 31 emits sound toward top wall 11e by allowing diaphragm 31a to resonate with air in internal space 11g. It is to be noted that the air in internal space 11g resonates with second speaker 22 when diaphragm 22a of second speaker 22 is vibrated.

First passive radiator 31 has an aperture that is similar to the aperture of second speaker 22, and a frequency characteristic that is similar to the frequency characteristic of second speaker 22. However, with regard to the structure and the installation position of first passive radiator 31, the above-described structural example is not at all limiting. For example, first passive radiator 31 may be disposed at any of front wall 11a, rear wall 11b, and side wall 11c or may have an aperture different from the aperture of second speaker 22.

As illustrated in FIG. 5, second speaker 22 and first passive radiator 31 share internal space 11g as their rear space. It is to be noted here that internal space 11g is an example of a first space. In other words, second speaker 22 and first passive radiator 31 have, as their common rear space, the first space (internal space 11g) that is separate from (or divided from the sound guide space without communicating with) the sound guide space (internal space 11h) in housing 10. The rear space for second speaker 22 is a space positioned (in the Y-axis negative direction) opposite to the direction (Y-axis positive direction) in which second speaker 22 outputs sound. The rear space for first passive radiator 31 is a space positioned (in the Y-axis negative direction) opposite to the direction (Y-axis positive direction) in which first passive radiator 31 outputs sound.

Internal space 11g forms a resonant space between second speaker 22 and first passive radiator 31. As such, first passive radiator 31 resonates with internal space 11g resonating with vibration of diaphragm 22a of second speaker 22. Because of vibration effected by this resonance, sound is emitted into the sound guide space (internal space 11h) that is positioned above first passive radiator 31 (in the positive direction of the Y-axis).

As illustrated in FIG. 5, bottom wall 11f of main body 11 of housing 10 is recessed in a direction from bottom wall 11f to top wall 11e (in the positive direction of the Y-axis) to have depression 11fa that has the shape of a circular truncated cone. One second passive radiator 32 is embedded at a bottom of depression 11fa.

Second passive radiator 32 is positioned above (on a Y-axis positive side of) bottom wall 11f inside internal space 11g and has its diaphragm 32a that is exposed at the bottom of depression 11fa to face downward (in the negative direction of the Y-axis) from bottom wall 11f. Second passive radiator 32 is disposed at the bottom of depression 11fa with its sound output direction being downward (the negative direction of the Y-axis) so as to output sound downward (in the negative direction of the Y-axis) from bottom wall 11f of housing 10.

The bottom of depression 11fa is positioned so that second passive radiator 32 does not interfere with a lower part of second speaker 22. In other words, depression 11fa is positioned so that second passive radiator 32 disposed at the bottom of depression 11fa does not overlap second speaker 22 (or is shifted sideward from second speaker 22) when housing 10 is viewed from above in the negative direction of the Y-axis (or from below in the positive direction of the Y-axis). In this way, vertical height (Y-axis dimension) increase of housing 10 including depression 11fa and second passive radiator 32 can be suppressed.

As illustrated in FIG. 5, second passive radiator 32 of the present exemplary embodiment is disposed directly underneath first passive radiator 31 (in a position vertically opposite from first passive radiator 31 (along the Y-axis)). In other words, second passive radiator 32 is positioned to overlap first passive radiator 31 when housing 10 is viewed from above in the negative direction of the Y-axis (or from below in the positive direction of the Y-axis).

In the present exemplary embodiment, second passive radiator 32 has substantially the same structure as first passive radiator 31. As described above, second passive radiator 32 is disposed in housing 10 with its sound output direction being vertically opposite from first passive radiator 31 (along the Y-axis). Inside housing 10, second passive radiator 32 and first passive radiator 31 are disposed, as described above, substantially in the same position on the front-back line (the Z-axis) and the left-right line (X-axis) (or substantially in the same position on the horizontal plane or X-Z plane). As such, a vibration direction of diaphragm 31a of first passive radiator 31 and a vibration direction of diaphragm 32a of second passive radiator 32 have vertical (Y-axis) linearity.

Second speaker 22, first passive radiator 31, and second passive radiator 32 share internal space 11g as their rear space. It is to be noted here that internal space 11g is the example of the first space. In other words, second speaker 22, first passive radiator 31, and second passive radiator 32 have, as their common rear space, the first space (internal space 11g) that is separate from (or divided from the sound guide space without communicating with) the sound guide space (internal space 11h) in housing 10. The rear space for second passive radiator 32 is a space positioned (in the Y-axis positive direction) opposite to the direction (Y-axis negative direction) in which second passive radiator 32 outputs sound. As such, internal space 11g forms the resonant space among second speaker 22, first passive radiator 31, and second passive radiator 32.

As illustrated in FIG. 5, cover 11fb having the shape of a bottomed flat cylinder is provided in depression 11fa of bottom wall 11f to cover second passive radiator 32 from below (from a Y-axis negative side of second passive radiator 32) in spaced relation to second passive radiator 32. Cover 11fb formed does not project downward (in the negative direction of the Y-axis) from bottom wall 11f (a Y-axis negative side of bottom wall 11f) where depression 11fa is surrounded. Thus, speaker device 100 can be mounted stably on television stand 2. Cover 11fb may be formed as a member separate from bottom wall 11f or may be formed integrally with bottom wall 11f.

Cylindrical side part 11fbb of cover 11fb is formed with a plurality of openings 11fba. Second passive radiator 32 emits sound toward cover 11fb by allowing diaphragm 32a to resonate with the air in internal space 11g. A portion of the sound emitted from second passive radiator 32 changes its travelling direction by striking against cover 11fb and diffuses out of housing 10 through the plurality of openings 11fba. While the plurality of openings 11fba are arranged throughout a periphery of side part 11fbb of cover 11fb in the present exemplary embodiment, the present disclosure is not limited to this structure. To give directivity to sound that is emitted from cover 11fb, the plurality of openings 11fba may be disposed, for example, in a portion (e.g. only in a front-wall-end portion) of side part 11fbb of cover 11fb. It is to be noted that with regard to the structure and the installation position of second passive radiator 32, the above-described structural example is not at all limiting. For example, second passive radiator 32 may be disposed at any of front wall 11a, rear wall 11b, and side wall 11c or may be disposed in a position that is not opposite from first passive radiator 31. Second passive radiator 32 may have another alternative structure that is different from first passive radiator 31.

With speaker device 100 having such structure as described above, housing 10 can be formed to have its vertical height (Y-axis dimension) reduced (to about 5 cm, for example) while including first speakers 21 each having the aperture of about 4 cm in diameter at front wall 11a, second speaker 22 and first passive radiator 31 each having the aperture that is about 8 cm in diameter at floor partition 11ka, and second passive radiator 32 having the aperture that is about 8 cm in diameter at bottom wall 11f.

Generally, a speaker and a passive radiator respectively have significantly small dimensions in their sound emitting directions with respect to their apertures. In speaker device 100, second speaker 22, first passive radiator 31, and second passive radiator 32 are disposed, as described above, with each of their sound output directions being either upward or downward (either the positive or negative direction of the Y-axis), thereby significantly reducing a vertical (Y-axis) area that these members occupy inside housing 10.

As illustrated in FIG. 5, provided in internal space 11i are drive circuit 51 that drives first speakers 21 and second speaker 22, and connector 52 that electrically interconnects drive circuit 51 and a device (such as television set 1) installed to be external to speaker device 100. It is to be noted here that internal space 11i is an example of a second space. In other words, speaker device 100 includes drive circuit 51, which drives first speakers 21 and second speaker 22, in the second space (internal space 110 that is separate from (or divided from the sound guide space without communicating with) the sound guide space (internal space 11h) in housing 10. The above-mentioned second space (internal space 110 that is formed is also separate from (or divided from the first space without communicating with) the first space (internal space 11g) that second speaker 22 has as its rear space in housing 10. Thus, drive circuit 51 for first speakers 21 and second speaker 22 of speaker device 100 is disposed in the second space (internal space 110 that is divided from the spaces (internal space 11h functioning as the sound guide space, and internal space 11g functioning as the resonant space) in which air vibration is effected by sound. In this way, drive circuit 51 can have a reduced effect on sound (air vibration effected by sound) in speaker device 100. Deterioration of an electric circuit such as drive circuit 51 can be advanced by continuous application of vibration effected by sound and others. In speaker device 100, however, drive circuit 51 is disposed in the second space (internal space 11i) where drive circuit 51 is less susceptible to direct air vibration effected by sound, so that such deterioration can be suppressed for drive circuit 51. Connector 52 is electrically connected to drive circuit 51. By being physically connected, via an electrical signal transmission cable or the like, to an electrical signal output connector of the device (such as television set 1) external to speaker device 100, connector 52 electrically interconnects drive circuit 51 and the device (such as television set 1) external to speaker device 100. In this way, an electrical audio signal transmitted from the device (such as television set 1) external to speaker device 100 is transmitted to drive circuit 51. Drive circuit 51 includes an amplifier that amplifies electrical audio signals in order to amplify an electrical signal that drive circuit 51 receives from the device (such as television set 1) external to speaker device 100 for output to first speakers 21 and second speaker 22. It is to be noted that the present disclosure is not limited to the structural example having drive circuit 51 in internal space 11i. Drive circuit 51 may be provided, for example, in a unit that is installed to be external to housing 10 or in a device different from speaker device 100.

### 1-2. Operation of Speaker Device

A description is hereinafter provided of operation of speaker device 100 according to the first exemplary embodiment.

Drive circuit 51 in housing 10 of speaker device 100 receives an electrical audio signal that is transmitted via connector 52 from the device (such as television set 1) external to speaker device 100, amplifies the electrical signal and outputs an amplified electrical signal to first speakers 21 and second speaker 22.

According to the input electrical signal from drive circuit 51, first speakers 21 have their diaphragms 21a driven, thus emitting sounds corresponding to the electrical signal forward (in the positive direction of the Z-axis).

According to the input electrical signal from drive circuit 51, second speaker 22 has its diaphragm 22a driven, thus emitting sound corresponding to the electrical signal toward top wall 11e of housing 10. A portion of the sound emitted from second speaker 22 changes its travelling direction by striking against top wall 11e and travels through the sound guide space (internal space 11h) toward slit 11aa. In the course of its travel, the sound is given directivity by the plurality of guides 11kd. When emitted out of housing 10 through slit 11aa, the sound given the directivity by guides 11kd is diffused forwardly of slit 11aa (in the positive direction of the Z-axis) between the substantially horizontal line and the downward line (negative direction of the Y-axis) by diffusive lead-through part 11ha.

With diaphragm 22a of second speaker 22 vibrating according to the input electrical signal from drive circuit 51, the air in space 11g of housing 10 resonates. Accordingly, diaphragm 31a of first passive radiator 31 and diaphragm 32a of second passive radiator 32 vibrate. With diaphragm 31a vibrating, first passive radiator 31 emits sound toward top wall 11e of housing 10 in the sound guide space (internal space 11h). In the sound guide space (internal space 11h), the sound emitted from first passive radiator 31 reinforces the sound (particularly in a lower range) emitted from second speaker 22. With diaphragm 32a vibrating, second passive radiator 32 emits sound toward a side periphery of second passive radiator 32 (along a line parallel to the X-Z plane). The sound emitted from second passive radiator 32 also reinforces the sound (particularly in the lower range) emitted from second speaker 22.

With these operations in speaker device 100, the second speaker's sound that has excellent low-range sound quality as a result of having its lower range reinforced by first passive radiator 31 is emitted from slit 11aa (diffusive lead-through part 11ha) that is in a front central position of housing 10, while the sounds of first speakers 21 are emitted from both the sides of slit 11aa. First speakers 21 each have the relatively smaller aperture, thus being suitable for reproduction of mid- to high-range sounds rather than low-range sound. And yet speaker device 100 can enhance its low-range sound reproduction capability because of the sound emitted from slit 11aa.

The higher the sound range (i.e. the higher the frequency), the stronger the directivity of sound is. On the other hand, the lower the sound range (i.e. the lower the frequency), the weaker the directivity of sound is. In consideration of this property of sound, first speakers 21 of speaker device 100 are disposed to be evenly divided between the left and right sides (along the X-axis) of slit 11aa (so that the left and right sides of slit 11aa equally have two first speakers 21 each in the present exemplary embodiment). Accordingly, various sounds are output from speaker device 100 with the low-range sound of relatively weak directivity that is output from second speaker 22 being sandwiched by the high-range sounds of relatively strong directivity that are output from first speakers 21. Thus, speaker device 100 can suppress occurrence of such a phenomenon that a sound image covering from the low-range sound that is emitted from second speaker 22 through slit 11aa to the high-range sounds that are emitted from first speakers 21 is displaced and drawn toward one of the left and right sides of slit 11aa. In other words, speaker device 100 can suppress the occurrence of the sound image displacement with regard to all sounds in its reproducible frequency bands.

In speaker device 100, first passive radiator 31 is disposed at an internal upper position of housing 10 (in the positive direction of the Y-axis), while second passive radiator 32 is disposed at an internal lower position of housing 10 (in the negative direction of the Y-axis). Diaphragm 31a of first passive radiator 31 and diaphragm 32a of second passive radiator 32 vibrate in the vertically opposite directions (along the Y-axis). Thus, in internal space 11g of housing 10, air pulsations in vertically opposite directions are canceled by first passive radiator 31 and second passive radiator 32. Consequently, speaker device 100 can achieve reduced vertical (Y-axis) vibration of housing 10.

It is to be noted that top wall 11e of housing 10 may be made of a material (such as resin) that can be vibrated by sound of second speaker 22. In the case of this structure, top wall 11e produces sound by being vibrated by the sound of second speaker 22, so that sound that is output out of housing 10 through the sound guide space (internal space 11h) can be reinforced in the lower range.

In the structural example of speaker device 100 that is described in the present exemplary embodiment, the sound guide space (internal space 11h) is provided at an internal upper part of housing 10 (in the positive direction of the Y-axis), and second speaker 22 is disposed in housing 10 to be oriented upward (in the positive direction of the Y-axis). However, it is to be noted that the present disclosure is not limited to this structural example at all. In speaker device 100, the sound guide space (internal space 11h) may be provided, for example, at an internal lower part of housing 10 (in the negative direction of the Y-axis), and second speaker 22 may be disposed in housing 10 to be oriented downward (in the negative direction of the Y-axis). In other words, in speaker device 100, the sound guide space (internal space 11h) and second speaker 22 may be vertically inverted with respect to the structure shown in FIG. 5.

In the structural example of speaker device 100 that is described in the present exemplary embodiment, floor partition 11ka has two openings 11kb and 11kc. However, it is to be noted that the present disclosure is not limited to this structural example at all. Floor partition 11ka may have one opening or not less than three openings. In cases where floor partition 11ka has one opening, second speaker 22 is disposed in that opening. In cases where floor partition 11ka has not less than three openings, second speaker 22, first passive radiator 31, or another speaker may be disposed in each of the third and following openings.

### 1-3. Effects and Others

As described above, the speaker device according to the present exemplary embodiment includes a housing that has a sound guide space having a vertically flattened shape, a first speaker disposed in the housing to be oriented toward a front of the housing, and a second speaker that is disposed in the housing and is oriented upward or downward to output sound into the sound guide space positioned at an internal upper part or an internal lower part of the housing. The sound guide space opens at an opening that is formed in vertically flattened form in the housing, and the opening has a vertical height that is smaller than an aperture of the first speaker.

Alternatively, a speaker device according to the present exemplary embodiment includes a housing that has a sound guide space having a vertically flattened shape, a first speaker disposed in the housing to be oriented toward a front of the housing, and a second speaker that is disposed in the housing and is oriented upward to output sound into the sound guide space positioned at an internal upper part of the housing. The sound guide space opens at an opening that is formed in vertically flattened form in the housing, and the opening has a vertical height that is smaller than an aperture of the first speaker.

It is to be noted that speaker device 100 is an example of the speaker device. Internal space 11h is an example of the sound guide space having the vertically flattened shape. Housing 10 is an example of the housing. First speaker 21 is an example of the first speaker. Second speaker 22 is an example of the second speaker. Slit 11aa is the example of the opening that is formed in vertically flattened form in the housing.

In the example shown in the first exemplary embodiment, for example, speaker device 100 includes housing 10 that has the sound guide space (internal space 11h) having the vertically flattened shape, first speakers 21 disposed in housing 10 to be oriented toward the front of housing 10, and second speaker 22 that is disposed in housing 10 and is oriented upward to output sound into the sound guide space (internal space 11h) positioned at the internal upper part of housing 10. The sound guide space (internal space 11h) opens at slit 11aa that is formed in vertically flattened form in housing 10, and slit 11aa has the vertical height (e.g. 1 cm) that is smaller than the aperture (e.g. 4 cm) of each of the first speakers 21.

In the speaker device, the sound guide space may extend from a front wall of the housing to a rear wall of the housing while the sound guide space having a vertical height substantially equal to the vertical height of the opening.

It is to be noted that front wall 11a is an example of the front wall. Rear wall 11b is an example of the rear wall.

In the example shown in the first exemplary embodiment, for example, the sound guide space (internal space 11h) of speaker device 100 extends (depthwise or along the Z-axis) from front wall 11a to rear wall 11b of housing 10 while the sound guide space (internal space 11h) having the vertical height (e.g. 1 cm) substantially equal to the vertical height of slit 11aa.

In the speaker device, the housing may include a floor partition that extends in substantially parallel relation to a top wall of the housing while the floor partition being in spaced relation to the top wall. The sound guide space may be formed to include the top wall and the floor partition of the housing.

It is to be noted that top wall 11e is an example of the top wall. Floor partition 11ka is an example of the floor partition.

In the example shown in the first exemplary embodiment, for example, housing 10 of speaker device 100 includes floor partition 11ka that extends in substantially parallel relation to top wall 11e of housing 10 while floor partition 11ka being in spaced relation to top wall 11e. The sound guide space (internal space 11h) is formed by top wall 11e and floor partition 11ka of housing 10.

In the speaker device, the floor partition may include one or a plurality of openings. The second speaker may be disposed in the opening of the floor partition to output sound toward the top wall of the housing with its diaphragm exposed to the sound guide space.

It is to be noted that opening 11kb and opening 11kc are examples of the plurality of openings of the floor partition. Diaphragm 22a is an example of the diaphragm of the second speaker.

In the speaker device, the floor partition may include a plurality of openings. The second speaker may be disposed in one of the plurality of openings of the floor partition to output sound toward the top wall of the housing with its diaphragm exposed to the sound guide space. A passive radiator may be disposed in another one of the plurality of openings of the floor partition so that its diaphragm faces the top wall of the housing while the diaphragm being exposed to the sound guide space.

It is to be noted that opening 11kb is an example of the one of the openings in the floor partition. Opening 11kc is an example of the other one of the openings in the floor partition. First passive radiator 31 is an example of the passive radiator. Diaphragm 31a is an example of the diaphragm of the passive radiator.

In the example shown in the first exemplary embodiment, for example, floor partition 11ka of speaker device 100 includes opening 11kb and opening 11kc. Second speaker 22 is disposed in opening 11kb to output sound toward top wall 11e of housing 10 with its diaphragm 22a exposed to the sound guide space (internal space 11h). First passive radiator 31 is disposed in opening 11kc so that its diaphragm 31a faces top wall 11e of housing 10 while diaphragm 31a being exposed to the sound guide space (internal space 11h).

In the speaker device, the passive radiator and the second speaker may have, as their common rear space, a first space that is separate from the sound guide space in the housing.

It is to be noted that internal space 11g is the example of the first space.

In the example shown in the first exemplary embodiment, for example, first passive radiator 31 and second speaker 22 of speaker device 100 have, as their common rear space, internal space 11g that is separate from (or divided from the sound guide space without communicating with) the sound guide space (internal space 11h) in housing 10.

In the speaker device, a horizontal length of the opening formed in the housing may be greater than a diameter of the floor partition's opening in which the second speaker is disposed.

In the example shown in the first exemplary embodiment, for example, the horizontal (X-axis) length of slit 11aa formed in housing 10 of speaker device 100 is greater than the diameter of opening 11kb in which second speaker 22 is disposed.

The speaker device may include, in a second space that is separate from the sound guide space in the housing, a drive circuit that drives the first speaker and the second speaker. The second space may be formed separately in the housing from a first space that is a rear space for the second speaker.

It is to be noted that internal space 11i is the example of the second space. Drive circuit 51 is an example of the drive circuit.

In the example shown in the first exemplary embodiment, for example, speaker device 100 includes, in internal space 11i that is separate from (or divided from the sound guide space without communicating with) the sound guide space (internal space 11h) in housing 10, drive circuit 51 that drives first speakers 21 and second speaker 22. Internal space 11i is formed to be separate from (or to be divided from internal space 11g without communicating with) internal space 11g that is a rear space for second speaker 22.

In speaker device 100 thus formed, second speaker 22 is disposed in housing 10 with its sound output direction being upward (the positive direction of the Y-axis), so that a vertical (Y-axis) area that second speaker 22 occupies inside housing 10 when disposed is less influenced by aperture size of second speaker 22.

As such, even with a relatively larger aperture of second speaker 22, speaker device 100 can achieve suppressed vertical height (Y-axis dimension) increase of housing 10. In other words, with the vertical height (Y-axis dimension) of speaker device 100 suppressed, second speaker 22 of speaker device 100 can be a subwoofer (or woofer) that has a relatively larger aperture and can suitably reproduce low-range sound.

Speaker device 100 includes the plurality of first speakers 21 oriented forward (in the positive direction of the Z-axis), and these plurality of first speakers 21 are arranged in the horizontal line (along the X-axis). With second speaker 22 being the subwoofer (or woofer) that has the relatively larger aperture and can suitably reproduce low-range sound, first speakers 21 can be small-size full-range speakers that each have an aperture smaller than the aperture of second speaker 22 and can suitably reproduce mid- to high-range sounds, or can be tweeters that can suitably reproduce high-range sounds. Even by these structures, speaker device 100 can have its vertical height (Y-axis dimension) suppressed.

Since second speaker 22 is disposed to output sound into the sound guide space (internal space 11h), the sound output into the sound guide space (internal space 11h) from second speaker 22 passes through the sound guide space (internal space 11h) and is emitted out forwardly of housing 10 (in the positive direction of the Z-axis) through slit 11aa. The sound output direction of each of first speakers 21 is forward (the positive direction of the Z-axis), so that sounds output from first speakers 21 are emitted out forwardly of housing 10 (in the positive direction of the Z-axis). As such, the sounds respectively output from first speakers 21 and second speaker 22 of speaker device 100 are emitted out forwardly of housing 10 (in the positive direction of the Z-axis).

Thus, speaker device 100 can be formed to emit the respective sounds of its speakers forward while achieving size increase of the aperture of second speaker 22 and the suppressed vertical height (Y-axis dimension) increase of housing 10. With the aperture size of the speaker increased, an improved low-range output characteristic can be achieved for the speaker. As such, speaker device 100 can even have reinforced low-range output.

With each of first speakers 21 having a relatively smaller aperture and being suited for reproduction of high-range sound or mid- to high-range sounds, such as the full-range speaker or the tweeter, and with second speaker 22 having a relatively larger aperture and being suited for reproduction of low-range sound, such as the subwoofer (or the woofer), speaker device 100 is capable of satisfactory output from low-range sound to high-range sound.

In speaker device 100, the sound guide space (internal space 11h) is disposed above second speaker 22 (in the positive direction of the Y-axis) and has the shape that is vertically flattened (along the Y-axis). The vertical height (Y-axis dimension) of the sound guide space (internal space 11h) is substantially equal to the vertical height (Y-axis dimension) of slit 11aa, which is the opening of the sound guide space (internal space 11h). The sound guide space (internal space 11h) having such a shape enables a reduced vertical (Y-axis) area that is necessary above second speaker 22 (in the positive direction of the Y-axis) in housing 10 for disposition of the sound guide space (internal space 11h). The vertically flattened sound guide space (internal space 11h) can increase pressure of sound that is output from second speaker 22 and can allow the sound to spread horizontally and to have directivity toward the front of housing 10 (in the positive direction of the Z-axis) when passing through the sound guide space (internal space 11h) to be emitted out of housing 10. Thus, speaker device 100 can provide powerful sound to its user.

In speaker device 100, the sound guide space (internal space 11h) opens at slit 11aa that is formed in housing 10 to be vertically flattened (along the Y-axis). The vertical height (Y-axis dimension of 1 cm, for example) of slit 11aa is smaller than the aperture (e.g. 4 cm) of first speaker 21. By having such a shape, slit 11aa of speaker device 100 can allow the second speaker's output sound coming through the sound guide space (internal space 11h) to moderately spread horizontally and to have forward directivity from housing 10 (in the positive direction of the Z-axis). As such, even when the user listening to sounds emitted from speaker device 100 shifts his or her head horizontally (in a direction parallel to the X-Z plane), the user can satisfactorily listen to the sound output from second speaker 22.

In speaker device 100, diffusive lead-through part 11ha is provided in front of slit 11aa (in the positive direction of the Z-axis). This means that sound coming through the sound guide space (internal space 11h) is emitted out forwardly of housing 10 through diffusive lead-through part 11ha of speaker device 100. Diffusive lead-through part 11ha is shaped to broaden vertically (along the Y-axis) while heading forward (in the positive direction of the Z-axis) toward its end. By having such a shape, diffusive lead-through part 11ha of speaker device 100 can vertically diffuse (along the Y-axis) the second speaker's output sound that has, as described above, the directivity as a result of coming through the sound guide space (internal space 11h) and slit 11aa and can allow that sound to have forward directivity (in the positive direction of the Z-axis). As such, even when the user listening to sounds emitted from speaker device 100 shifts his or her head vertically (along the Y-axis), the user can satisfactorily listen to the sound output from second speaker 22.

Speaker device 100 includes the plurality of first speakers 21, and these plurality of first speakers 21 are disposed on the left and right sides (along the X-axis) of slit 11aa through which sound output from second speaker 22 exits. In speaker device 100, second speaker 22 having the relatively larger aperture (e.g. 8 cm) suitably outputs low-range sound as compared with first speaker 21. It is known that the lower the sound range, the weaker the sound's directivity is. In speaker device 100, however, first speakers 21 that output high-range sounds of relatively strong directivity are disposed to be oriented forward (in the positive direction of the Z-axis) on both the sides of slit 11aa where sound output from second speaker 22 is emitted out forwardly of housing 10 (in the positive direction of the Z-axis). As such, speaker device 100 can suppress displacement of sound to localize ranging from low-range sound output from second speaker 22 to high-range sounds output from first speakers 21 to the position of the particular speaker. When the plurality of first speakers 21 are disposed on a left and right side of second speaker 22, it is to be noted that in consideration of an actual feeling of sound spreading, how the sound is actually heard, and others, first speakers 21 disposed relatively closer to slit 11aa may be, for example, speakers having a lower range frequency characteristic (or a higher range frequency characteristic) than that of first speakers 21 disposed relatively farther from slit 11aa.

Speaker device 100 includes first passive radiator 31 in housing 10, and first passive radiator 31 and second speaker 22 have, as their common rear space, the first space (internal space 11g) that is separate from (or divided from the sound guide space without communicating with) the sound guide space (internal space 11h) in housing 10. In speaker device 100 thus formed, first passive radiator 31 resonates with the air vibrated by second speaker 22 in internal space 11g, thus producing sound. By having its diaphragm 31a vibrated through the resonance, first passive radiator 31 suitably outputs low frequency sound (low-range sound). In this way, speaker device 100 can have low-range sound reinforced.

In speaker device 100, first passive radiator 31 is disposed in housing 10 in such a direction as to output sound into the sound guide space (internal space 11h). In other words, first passive radiator 31 is disposed in substantially the same direction as second speaker 22 in housing 10. In speaker device 100 thus formed, the lower range of sound output from second speaker 22 is directly reinforced by first passive radiator 31. In other words, among sounds output from speaker device 100, the low-range sound can be reinforced by first passive radiator 31 in speaker device 100. By being disposed in substantially the same direction as second speaker 22 in housing 10 of speaker device 100, first passive radiator 31 can achieve, similarly to second speaker 22, suppressed vertical height (Y-axis dimension) increase of housing 10 while achieving size increase of its aperture.

Speaker device 100 includes the plurality of passive radiators (first passive radiator 31 and second passive radiator 32), and first passive radiator 31 and second passive radiator 32 are disposed in housing 10 in opposite directions in the vertical direction (along the Y-axis). In speaker device 100 thus formed, first passive radiator 31 and second passive radiator 32 vibrate in the vertically opposite directions (along the Y-axis). As such, speaker device 100 can reduce vibration that might be caused to housing 10 by the vibrations of first and second passive radiators 31 and 32. With either one of first and second passive radiators 31 and 32 being disposed in the same direction as second speaker 22, speaker device 100 can also reduce vibration that might be caused to housing 10 by the vibration of second speaker 22.

In housing 10 of speaker device 100, drive circuit 51 that drives first speakers 21 and second speaker 22 is included in the second space (internal space 11i) that is separate from (or divided from the sound guide space without communicating with) the sound guide space (internal space 11h). The second space (internal space 110 is formed to be separate from (or to be divided from the first space without communicating with) the first space (internal space 11g) that second speaker 22 has as its rear space in housing 10. Speaker device 100 thus formed includes drive circuit 51, first speakers 21, second speaker 22 and the others as one unit in housing 10, so that a system including speaker device 100 and the device (such as television set 1) that is installed to be external to speaker device 100 and is connected to speaker device 100 can be of simplified configuration. In speaker device 100, the second space (internal space 11i) accommodating drive circuit 51 is separate from the sound guide space (internal space 11h) and the first space (internal space 11g), both of which are where air vibration is effected by sound. In other words, drive circuit 51 of speaker device 100 is disposed in the second space (internal space 11i) that is divided from and does not communicate with the sound guide space (internal space 11h) and the first space (internal space 11g) and thus is less susceptible to direct air vibration effected by sound. It is for this reason that drive circuit 51 can have a reduced effect on sound (air vibration effected by sound) in speaker device 100. Because drive circuit 51 is less influenced by direct air vibration effected by sound, deterioration that might gradually be advanced by continuous application of vibration can be suppressed for drive circuit 51.

### Other Exemplary Embodiments

The first exemplary embodiment has been described above as being illustrative of the technique disclosed in the present application. However, the above exemplary embodiment is not restrictive of the present disclosure. For example, other exemplary embodiments that are realized by combining the constituent elements of choice that are described in this description or omitting some of the constituent elements may also be exemplary embodiments of the present disclosure. Also included in the present disclosure are modifications that are obtained by making to the above exemplary embodiment various changes that may be conceived of by those skilled in the art without departing from the spirit of the present disclosure, that is to say, the meaning of the recitations in the claims.

Accordingly, some other exemplary embodiments are described below.

In the structural example of speaker device 100 that is described in the first exemplary embodiment, speaker device 100 includes four first speakers 21 and one second speaker 22; however, the present disclosure is not limited to this structural example. Speaker device 100 may include not less than one first speaker 21 and not less than one second speaker 22.

In the structural example of speaker device 100 that is described in the first exemplary embodiment, speaker device 100 includes first speakers 21 on both the sides (along the X-axis) of slit 11aa through which sound output from second speaker 22 is emitted. However, the present disclosure is not limited to this structural example. Speaker device 100 may be, for example, of structure that includes first speakers 21 only on one of the sides of slit 11aa. Speaker device 100 may be of another alternative structure that includes a plurality of slits 11aa and one or more slits 11aa may be disposed on both sides of first speakers 21. Speaker device 100 may be of yet another alternative structure that has not less than one first speaker 21 and not less than one slit 11aa that are alternately disposed horizontally (along the X-axis). Still yet another speaker device 100 may include a plurality of second speakers 22 that are arranged horizontally (along the X-axis) or depthwise (along the Z-axis) in housing 10.

In the structural example of speaker device 100 that is described in the first exemplary embodiment, speaker device 100 includes the two passive radiators (first passive radiator 31 and second passive radiator 32); however, the present disclosure is not limited to this structural example. Speaker device 100 may include not less than one passive radiator. In the structural example of speaker device 100 that is described in the first exemplary embodiment, first passive radiator 31 is disposed at floor partition 11ka that runs along top wall 11e of housing 10, while second passive radiator 32 is disposed at bottom wall 11f of housing 10. However, the present disclosure is not limited to this structural example. In speaker device 100, the passive radiator may be disposed at any of bottom wall 11f, floor partition 11ka, front wall 11a, side wall 11c, side wall 11d, and top wall 11e of housing 10. In cases where speaker device 100 includes the plurality of passive radiators in housing 10, the passive radiators may respectively be disposed at the housing's walls that face each other as described in the first exemplary embodiment or may respectively be disposed at the housing's walls that do not face each other.

In the structural example of speaker device 100 that is described in the first exemplary embodiment, slit 11aa, the sound guide space (internal space 11h), and diffusive lead-through part 11ha are disposed to be adjacent (or close) to top wall 11e of housing 10. However, the present disclosure is not limited to this structural example. Slit 11aa, the sound guide space (internal space 11h), and diffusive lead-through part 11ha of speaker device 100 may be positioned anywhere between top wall 11e and bottom wall 11f of housing 10 and may be, for example, adjacent to bottom wall 11f (in an internal lower position of housing 10).

In the structural example of speaker device 100 that is described in the first exemplary embodiment, slit 11aa and diffusive lead-through part 11ha are rectangular in shape; however, the present disclosure is not limited to this structural example. Instead of being rectangular, slit 11aa and diffusive lead-through part 11ha of speaker device 100 may have any shape such as a polygon, a circle, an oval, or an ellipse. In the structural example of speaker device 100 that is described in the first exemplary embodiment, slit 11aa and diffusive lead-through part 11ha are long horizontally (along the X-axis); however, the present disclosure is not limited to this structural example. Instead of being long horizontally, slit 11aa and diffusive lead-through part 11ha of speaker device 100 may be long in another direction (e.g. vertically or along the Y-axis).

In the structural example of speaker device 100 that is described in the first exemplary embodiment, diffusive lead-through part 11ha diffuses sound, which is output from second speaker 22 and comes through the sound guide space (internal space 11h), forwardly of slit 11aa (in the positive direction of the Z-axis) between the substantially horizontal line (parallel to the X-Z plane) and the downward line (negative direction of the Y-axis) and allows that sound to have directivity. However, the present disclosure is not limited to this structural example. For example, diffusive lead-through part 11ha of speaker device 100 may diffuse sound, which is output from second speaker 22 and comes through the sound guide space (internal space 11h), forwardly of slit 11aa (in the positive direction of the Z-axis) between the substantially horizontal line (parallel to the X-Z plane) and an upward line (positive direction of the Y-axis), or between the substantially horizontal line (parallel to the X-Z plane) and the upward line (positive direction of the Y-axis) as well as between the substantially horizontal line (parallel to the X-Z plane) and the downward line (negative direction of the Y-axis). Another alternative diffusive lead-through part 11ha may diffuse the sound leftward or rightward (along the X-axis), or both.

In the first exemplary embodiment, the described structural example of speaker device 100 is applied for use with television set 1; however, this structural example is not restrictive of the present disclosure. Speaker device 100 may be applied for use with any device that is configured to generate and output audio signals as external outputs.

The exemplary embodiments have been described above as being illustrative of the technique of the present disclosure, and the accompanying drawings and the detailed description have been provided accordingly.

For illustration of the above technique, the constituent elements that are illustrated in the appended drawings and are described in the detailed description may include not only the constituent elements that are essential for solving the problems but also the constituent elements that are not essential for solving the problems. For this reason, those inessential constituent elements that are illustrated in the appended drawings or are described in the detailed description should not immediately be acknowledged as essential.

Since the above exemplary embodiments are intended to be illustrative of the technique of the present disclosure, various modifications, replacements, additions, omissions, and others can be made within the scope of the claims or equivalents of the claims.

### INDUSTRIAL APPLICABILITY

The present disclosure is applicable to a speaker device including a plurality of speakers.

### REFERENCE MARKS IN THE DRAWINGS

1 television set
1a image display surface
2 television stand
10 housing
11 main body
11a front wall
11aa slit
11b rear wall
11c, 11d side wall
11e top wall
11f bottom wall
11fa depression
11fb cover
11fbb side part
11fba, 11kb, 11kc opening
11g, 11h, 11i internal space
11ha diffusive lead-through part
11j, 11k partition
11ka floor partition
11kd guide
12 front panel
13 directional member
13a directional surface
21 first speaker
21a, 22a, 31a, 32a diaphragm
22 second speaker
22b drive unit
31 first passive radiator
32 second passive radiator
51 drive circuit
52 connector
100 speaker device

1. A speaker device comprising:
a housing including a sound guide space that has a vertically flattened shape;
a first speaker disposed in the housing to be oriented toward a front of the housing; and
a second speaker disposed in the housing, the second speaker being oriented upward or downward to output sound into the sound guide space that is positioned at an internal upper part or an internal lower part of the housing,
wherein
the sound guide space opens at an opening that is formed in vertically flattened form in the housing, and
the opening has a vertical height that is smaller than an aperture of the first speaker.

2. A speaker device comprising:
a housing including a sound guide space that has a vertically flattened shape;
a first speaker disposed in the housing to be oriented toward a front of the housing; and
a second speaker disposed in the housing, the second speaker being oriented upward to output sound into the sound guide space that is positioned at an internal upper part of the housing,
wherein
the sound guide space opens at an opening that is formed in vertically flattened form in the housing, and
the opening has a vertical height that is smaller than an aperture of the first speaker.

3. The speaker device according to claim 2, wherein the sound guide space extends from a front wall of the housing to a rear wall of the housing while the sound guide space having a vertical height substantially equal to the vertical height of the opening.

4. The speaker device according to claim 2, wherein
the housing further includes a floor partition that extends in substantially parallel relation to a top wall of the housing while the floor partition being in spaced relation to the top wall, and
the sound guide space is formed to include the top wall and the floor partition of the housing.

5. The speaker device according to claim 4, wherein
the floor partition includes at least one opening, and
the second speaker is disposed in the opening of the floor partition to output sound toward the top wall of the housing with a diaphragm, of the second speaker, exposed to the sound guide space.

6. The speaker device according to claim 4, wherein
the floor partition includes a plurality of openings,
the second speaker is disposed in one of the plurality of openings of the floor partition to output sound toward the top wall of the housing with a diaphragm, of the second speaker, exposed to the sound guide space, and
a passive radiator is disposed in another one of the plurality of openings of the floor partition so that a diaphragm of the passive radiator faces the top wall of the housing while the diaphragm being exposed to the sound guide space.

7. The speaker device according to claim 6, wherein the passive radiator and the second speaker have, as a common rear space, a first space that is separate from the sound guide space in the housing.

8. The speaker device according to claim 5, wherein a horizontal length of the opening formed in the housing is greater than a diameter of the floor partition's opening in which the second speaker is disposed.

9. The speaker device according to claim 1, further comprising a drive circuit that drives the first speaker and the second speaker, the drive circuit being in a second space that is separate from the sound guide space in the housing,
wherein the second space is formed separately in the housing from a first space that is a rear space for the second speaker.

10. The speaker device according to claim 6, wherein a horizontal length of the opening formed in the housing is greater than a diameter of the floor partition's opening in which the second speaker is disposed.

11. The speaker device according to claim 7, further comprising a drive circuit that drives the first speaker and the second speaker, the drive circuit being in a second space that is separate from the sound guide space in the housing,
wherein the second space is formed separately in the housing from the first space that is a rear space for the second speaker.
